(19) United States
(12) Patent Application Publication
(10) Pub. No.: US 2004/0036187 A1
(43) Pub. Date: Feb. 26, 2004

(54) Method for producing an optical data band

(76) Inventors: Jorn Leiber, Hamburg (DE); Bernhard Mussig, Seevetal (DE); Stefan Stadler, Hamburg (DE)

Correspondence Address: NIXON & VANDERHYE, PC, 1100 N GLEBE ROAD, 8TH FLOOR, ARLINGTON, VA, 22201-4714, US

(21) Appl. No.: 10/297,477

(22) PCT Filed: May 22, 2001
(86) PCT No.: PCT/EP01/05875

(30) Foreign Application Priority Data
Jun. 7, 2000 (DE) 100 28 112.5

(51) Int. Cl. B29D 11/00

(52) U.S. Cl. 264/1.7

(57) ABSTRACT

The invention relates to a method for producing a data memory comprising an optical information carrier. Said information carrier comprises several stacked series of layers, which are disposed for storing information and which have a polymer support (35) and an intermediate layer (38). According to the inventive method, several layers (35, 36, 37, 38) of at least one series of layers (39) are co-extruded.

The invention relates to a method for producing a data memory with an optical information carrier.

DE 298 16 802 describes a data memory with an optical information carrier which contains a polymer film. Polymethyl methacrylate and the polymer film marketed by Beiersdorf AG under the designation. “tesafilm kristallklar”, which comprises biaxially oriented polypropylene, are mentioned as the material for the polymer film. In this data memory, the polymer film is wound spirally in a plurality of layers or plies on a winding core, an adhesion layer being respectively located between neighboring plies. The adhesion layer consists of an acrylate bonder. Information items can be written in the data memory by locally heating the polymer film with the aid of a write beam of a data drive, so that the refractive index and therefore the reflecting power (reflectivity) at the interface of the polymer film are locally changed. This can be picked up with the aid of a read beam in the data drive. By focusing the write beam or the read beam, information can be written to a preselected ply of the information carrier and read from it, respectively, in a controlled way. In order to facilitate the local heating of the polymer film, the polymer film may be assigned an absorber (for example a dye), which preferentially absorbs the write beam and locally delivers the heat thereby produced to the polymer film. The winding core may be optically transparent and have, at its center, a recess which is used to accommodate the write and read device of a data drive. In this case, the write and read device is moved relative to the data memory, while the data memory is stationary, so that the data memory does not need to be balanced with a view to a fast rotational movement.

In the previously known data memory, the elaborate production is disadvantageous. A layer with absorber dye needs to be applied to the polymer film, and an adhesion layer then needs to be applied. This layer sequence is subsequently wound spirally, so that a plurality of layer sequences designed for information storage are stacked. The many individual steps during production have an unfavorable effect on the costs.

It is an object of the invention to provide a method for producing a data memory with an optical information carrier which comprises a plurality of stacked layer sequences designed for information storage, each having a polymer carrier and an intermediate layer, which is cost-efficient and provides high-quality data memories.

This object is achieved by a method having the features of claim 1. Advantageous configurations of the invention are given in the dependent claims.

The method according to the invention is used for producing a data memory with an optical information carrier which comprises a plurality of layer sequences designed for information storage, each having a polymer carrier and an intermediate layer. In these layer sequences, a layer or ply is hence formed by a polymer carrier, and at least one further ply is provided, namely an intermediate layer. The intermediate layer may, for example, be designed as an adhesion layer in order to bond a layer sequence to a neighboring layer sequence. A layer sequence may, however, comprise additional layers, for example a layer with an absorber dye. In the optical information carrier, a plurality of such layer sequences are arranged stacked. According to the invention, a plurality of layers of at least one layer sequence are coextruded.

By coextruding a plurality of layers, a plurality of layers of a layer sequence are made simultaneously, or almost simultaneously, which saves on working steps and has a favorable effect on the production costs of the data memory. Advantageously, all the layers of a layer sequence are coextruded, so that the coextrudate can be processed to form the completed optical information carrier without further individual layers needing to be added.

There are in principle several ways in which the optical information carrier can be made from a layer sequence or a plurality of layer sequences.

In one embodiment of the method, the layers assigned to a layer sequence are coextruded and the information carrier is wound spirally therefrom. In this way, each turn of the spiral arrangement forms a ply or layer sequence, designed for information storage, of the optical information carrier. Since the extrudate has the thickness of only one layer sequence, the radial distance of the polymer carrier from the turn axis of the data memory changes relatively little over a turn, so that a read beam or write beam can be readily refocused over the layer sequence of a turn during reading or writing, respectively, of information in the data memory.

In another configuration of the method, the layers assigned to a plurality of layer sequences are coextruded together and the information carrier is wound spirally therefrom. In contrast to the previously mentioned configuration, the layers for a plurality of layer sequences are hence coextruded together, so that, for a data memory with a given number of layer sequences, the coextrudate can be wound with a smaller number of turns than in the previously explained embodiment of the invention. Owing to the larger thickness of the coextrudate, however, the radial displacement for each turn is greater than in the previously explained embodiment. With the aid of a drive suited to the data memory, a read beam or write beam can nevertheless be refocused over the profile of a turn of the coextrudate.

It is also possible for the layers of a plurality of, and advantageously all, the layer sequences to be coextruded together. In this case, the layers coextruded together may be bent into a ring after having been extruded. An alternative is for the layers coextruded together to be wound in a coil fashion to form a hollow cylindrical shape after having been extruded (in which case parts of the end regions of the coextrudate may protrude from the end sides of the hollow cylindrical shape). Annular information carriers for a plurality of data memories can be cut from a hollow cylindrical shape. In these embodiments, the individual layer sequences do not have a spiral profile, but are instead closed on themselves. In the cross section of the information carrier, the layers of the layer sequences may hence have the shape of concentric circular rings, for example. In this case, it is particularly straightforward to write information to the data memory, or to read it therefrom, since a write beam or a read beam does not need to be refocused over the profile of a layer sequence, or at most needs to be refocused only slightly in order to compensate for tolerances.

In another advantageous configuration of the method, the layers of all the layer sequences are coextruded together in the form of a seamless tube, the individual layers advantageously being arranged concentrically with one another. Annular information carriers for a plurality of data memories can be cut from such a tube. Only a few manufacturing steps are hence needed for producing a data memory, which is also more geometrically stable and, owing to its concentric structure, can be read from and written to in a favorable way.

Advantageously, the refractive index of the polymer carrier can be locally altered by heating. In this case, the polymer carrier may be assigned an absorber, which is designed to absorb a write beam at least partially, and to locally deliver the heat thereby produced at least partially to the polymer film. The absorber contains, for example, dye molecules which are contained in the polymer carrier or in a layer neighboring the polymer carrier, for example the intermediate layer, and it allows the polymer carrier to be locally heated sufficiently to alter the refractive index with a relatively low intensity of the write beam.

In a preferred configuration of the method, the coextruded layers are biaxially stretched after having been extruded. Such a method step may be carried out, for example, on coextrudates with the thickness of one layer sequence or of a plurality of layer sequences, which are subsequently wound or bent. Advantageously, a polymer film is used as the polymer carrier, that is to say the co-extrusion and optional stretching provides the polymer carrier with a layer thickness which corresponds to the thickness of a typical polymer film and, for example, lies between 10 μm and 100 μm, although it may also be smaller or larger. A suitable material for the polymer carrier is, for example, polypropylene which becomes biaxially oriented polypropylene (BOPP) after having been biaxially stretched. If polypropylene is prestressed in two planes after the co-extrusion, a high internal energy is stored in the material. Under local heating, for example by a write beam, a pronounced material change then takes place as a result of return deformation, and, specifically, merely by depositing a relatively small quantity of energy per unit area. In this way, for example, a change in the refractive index of about 0.2 can be achieved over an area for a stored information unit having a diameter or a side length of about 1 μm. A polymer film made of biaxially oriented polypropylene is therefore highly suitable as a polymer carrier whose refractive index can be locally altered by heating. Materials other than polypropylene, however, are likewise conceivable for the polymer carrier.

As the intermediate layer of a layer sequence, it is possible to use an adhesion layer, with the aid of which neighboring layer sequences can be bonded to one another. Examples of suitable adhesives are an acrylate bonder which is free from gas bubbles, or an acrylate hot-melt compound. Advantageously, the refractive index of the intermediate layer differs only slightly from the refractive index of the polymer carrier, in order to minimize perturbing reflections of a read beam or of a write beam at an interface between a polymer carrier ply and a neighboring intermediate layer. It is particularly advantageous for the refractive index difference to be less than 0.005. Any difference existing between the refractive indices, however, may be used for formatting the data memory. In the case of the seamlessly extruded tube explained above, for example, the polymer carrier in each layer sequence may be delimited optically from the polymer carrier of the neighboring layer sequence by an intermediate layer (which need not be configured as an adhesion layer in this case) having a slightly different refractive index.

In a preferred configuration of the invention, the information carrier is formed around a central core. For example, a coextrudate with the layers assigned to one layer sequence or a plurality of layer sequences may be wound around a central core that resembles a winding form. The winding form may subsequently remain in order to stabilize the data memory. In other configurations, the central core is merely an aid for the production process, and it is removed after winding.

The invention will be explained in more detail below with reference to exemplary embodiments. In the drawings,

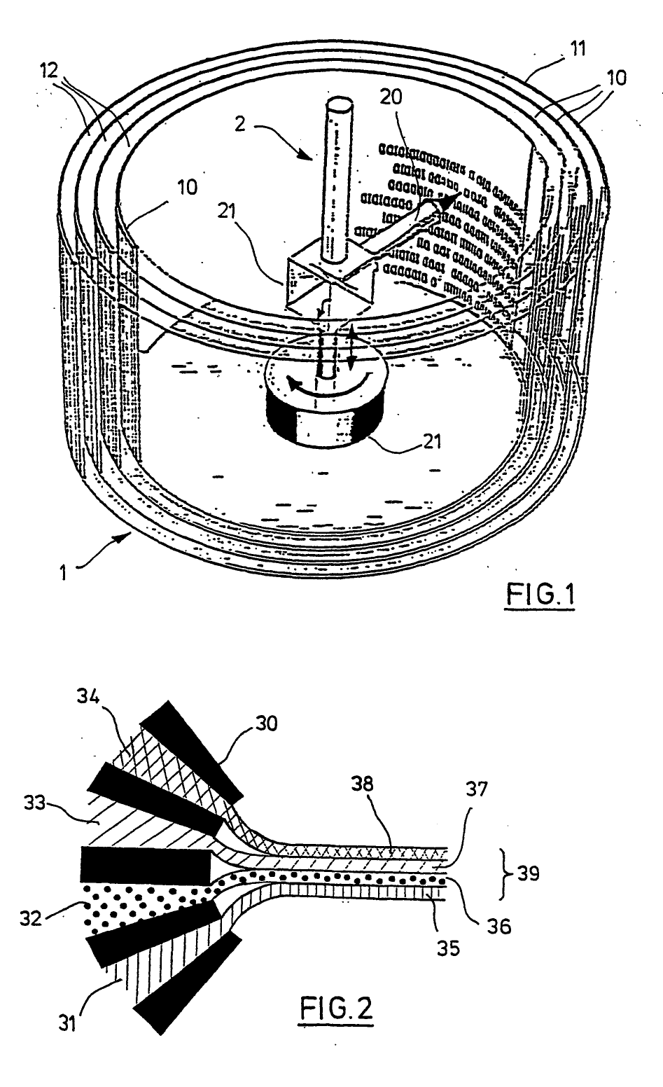

FIG. 1 shows a data memory which is produced by the method according to the invention, in a schematic perspective representation, with parts of a drive suited to the data memory being arranged in a recess in the central region of the data memory,

FIG. 2 shows a schematic representation of an extruder head, with which the layers of a layer sequence of the information carrier of the data memory in FIG. 1 are coextruded,

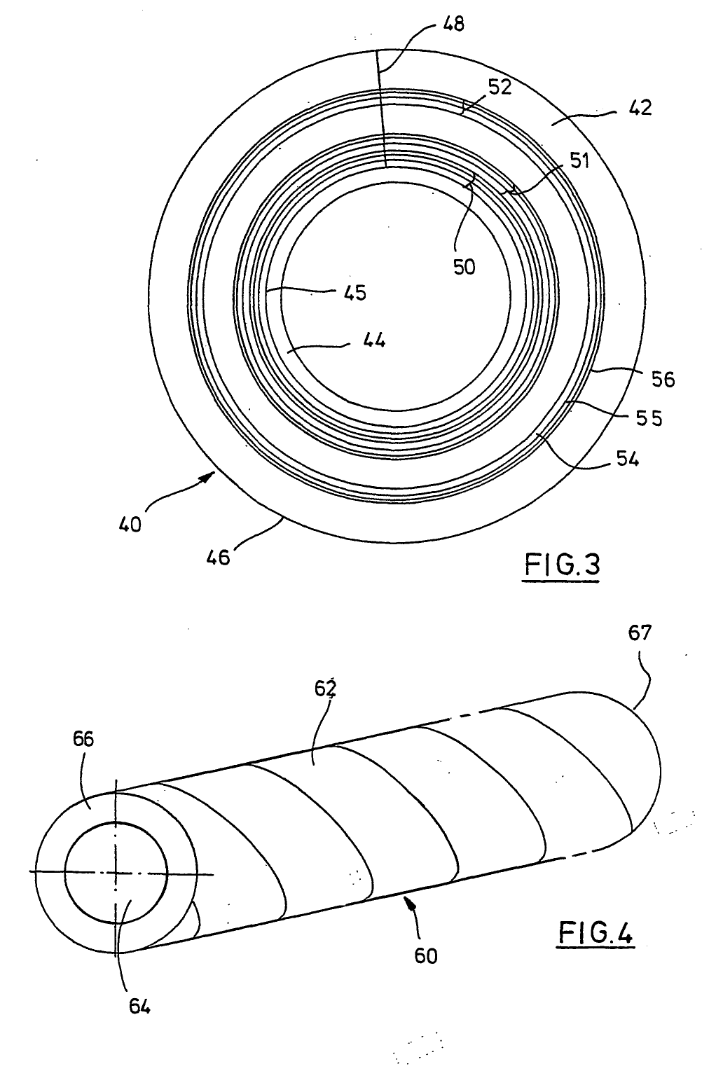

FIG. 3 shows a schematic cross section through a data memory, in which the layers of all the layer sequences of the information carrier are coextruded together and are bent into a ring,

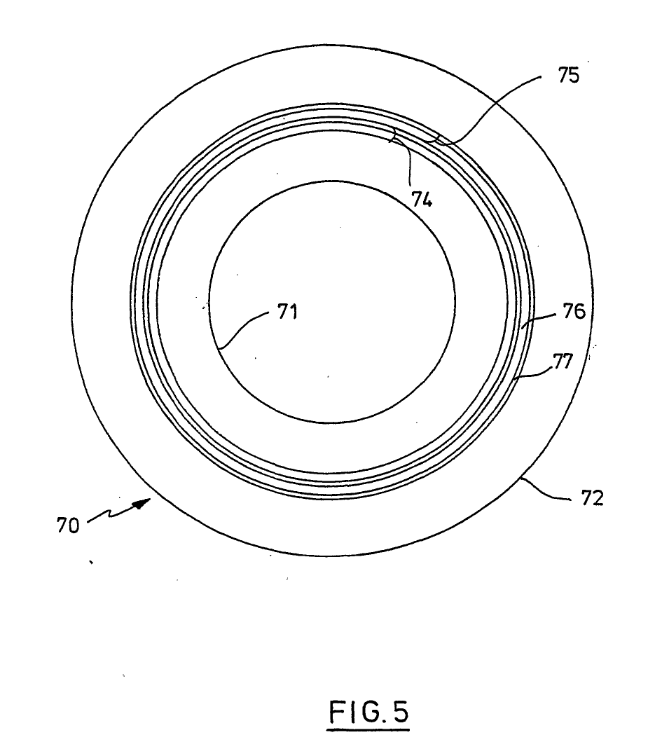

FIG. 4 shows a schematic perspective view of a hollow cylindrical shape, which is wound in a coil fashion from layers coextruded together, and from which annular information carriers for a plurality of data memories are cut, and

FIG. 5 shows a schematic cross section through a data memory, in which the layers of all the layer sequences of the information carrier are coextruded together in the form of a seamless tube.

FIG. 1 shows, in a schematic representation, a data memory 1 and a write and read device 2 of a drive suited to the data memory 1. The data memory 1 comprises an optical information carrier having a number of plies 10 of a polymer carrier, used for information storage, in the form of a polymer film 11 which is wound spirally on an optically transparent winding core. For the sake of clarity, the winding core is not shown in FIG. 1; it lies inside the innermost ply 10. For clearer illustration, the individual plies 10 of the polymer film 11 are shown as concentric circular rings in FIG. 1, although the plies 10 are formed by spirally winding the polymer film 11 in the exemplary embodiment. An intermediate layer 12, used as an adhesion layer, is respectively arranged between neighboring plies 10 of the polymer film 11. In the exemplary embodiment, the individual adhesion layers 12 are hence all connected and, overall, have a spiral profile just like the polymer film 11. For reasons of clarity, the adhesion layers 12 have been indicated in FIG. 1 with a thickness that has been enlarged in a way which is not true to scale. A ply 10 of the polymer film 11, together with a neighboring adhesion layer 12 and other layers that are not shown for the sake of clarity (such as an absorber layer which contains absorber dye), forms a layer sequence, as explained below with reference to FIG. 2.

In the exemplary embodiment, the polymer film 11 consists of biaxially oriented polypropylene (BOPP) and has been prestressed (see below) in both surface directions prior to winding (together with the other layers assigned to a layer sequence). In the exemplary embodiment, the polymer film 11 has a thickness of 35 μm; other thicknesses in the range of from 10 μm to 100 μm, or even thicknesses lying outside of this range, are likewise conceivable. The adhesion layers 12 are free from gas bubbles and, in the exemplary embodiment, they consist of acrylate bonder with a thickness of 23 μm, preferred layer thicknesses being between 1 μm and 40 μm. In the exemplary embodiment, the data memory 1 contains twenty plies 10 of the polymer film 11, and it has an external diameter of about 30 mm. Its height is about 19 mm. A different number of plies 10, or different dimensions, are likewise possible. The number of turns or plies 10 may, for example, be between ten and thirty, although it may also be more than thirty.

The write and read device 2 arranged in the interior of the winding core is known in principle, for example, from DVD technology. The write and read device 2 contains a write and read head 20, which, with the aid of a mechanism 21, can be rotated in the directions of the indicated arrows and moved axially to and fro. The write and read head 20 comprises optical elements, with the aid of which a light beam (for example with the wavelength 630 nm or 532 nm) produced by a laser, which is not shown in FIG. 1, can be focused onto the individual plies 10 of the polymer film 11. Since the write and read head 20 is moved with the aid of the mechanism 21, it can fully scan all the plies 10 of the data memory 1. In the exemplary embodiment, the data memory 1 is in this case stationary. It does not therefore need to be balanced with a view to a high rotational speed (and it does not need to be unspooled or respooled either), in contrast to the write and read head 20. For the sake of clarity, the elements intended to balance the write and read head 20 are not shown in FIG. 1. Said laser lies outside the write and read head 20 and is stationary; the laser beam is guided into the write and read head 20 via optical elements.

In order to store or write information in the data memory 1, the laser is operated with a beam power of about 1 mW in the exemplary embodiment. The laser beam is in this case used as a write beam, and it is focused onto a preselected ply 10 of the polymer film 11 so that the beam spot is smaller than 1 μm. The light energy is in this case input in the form of short pulses with a duration of about 10 μm. The energy of the write beam is absorbed in the beam spot, assisted by the absorber in the neighboring absorber layer, which leads to local heating of the polymer film 11 and hence to a local change in the refractive index and in the reflectivity. During the write process, the write beam is defocused in the plies neighboring the relevant ply 10 of the polymer film 11, so that the neighboring plies of the polymer film 11 are heated only slightly, and the information stored there is not altered.

In order to read stored information from the data memory 1, the laser is operated in the continuous-wave mode (CW mode) in the exemplary embodiment. The read beam focused onto the desired position is reflected as a function of the stored information, and the intensity of the reflected beam is picked up by a detector in the write and read device 2.

The data memory may also be of an embodiment which cannot be written to by the user. In this case, it contains information units written by the manufacturer. A write function in the user's data drive is then superfluous.

In the polymer film 11, the information units are formed by changing the optical properties in a region with a preferred size of less than 1 μm. In this case, the information may be stored in binary form, i.e. the local reflectivity takes only two values at the position of an information unit. This means that, for example, a “1” is stored at the relevant position on the information carrier when the reflectivity lies above a set threshold value, and a “0” is correspondingly stored when it is below this threshold value, or below another lower threshold value. It is, however, also conceivable to store the information in a plurality of gray levels. This is possible if the reflectivity of the polymer film can be altered in a controlled way by defined adjustment of the refractive index, but without reaching saturation.

FIG. 2 schematically illustrates the way in which the layers (such as the polymer film 11 and the continuous adhesion layer 12) associated with a layer sequence can be coextruded in order to produce the data memory 1 in FIG. 1.

The extruder used for this has an extruder head 30 with a plurality of outlet openings, from which a film raw material 31 (polypropylene in the exemplary embodiment), an absorber 32, a primer 33 and an adhesive 34 (an acrylate compound in the exemplary embodiment) emerge at elevated temperature. Behind the extruder head 30, these four starting materials converge and form four layers when cooled, namely the polymer film, which is denoted here by 35, an absorber layer 36, a primer layer 37 and the adhesion layer, which is denoted here by 38. The four layers 35 to 38 adhere to one another and form a layer sequence 39.

The absorber layer 36 comprises an absorber dye which is embedded in a binder and facilitates the heat production with the aid of a write beam (see above). Depending on the embodiment, the absorber dye may also be contained in the polymer film 35 or the adhesion layer 38, in which case the latter should be immediately next to the polymer film 35, or it may be entirely omitted, so that a separate absorber layer 36 is unnecessary in these cases. The primer layer 37 is used to promote tack between the absorber layer 36 and the adhesion layer 38, and it may likewise be unnecessary depending on the embodiment.

After having been coextruded, in the exemplary embodiment the coextruded layers 35, 36, 37, 38 are biaxially stretched together, so that the polymer film 35 becomes a film of biaxially oriented polypropylene (BOPP), a material in which a high internal energy is stored (see above).

In one example in relation to FIGS. 1 and 2, the temperature of the extruder head 30 is 120-150° C. A mixture of 0.01-0.1% by weight of the absorber dye Sudan Red 7B, in acrylate hot melt as a binder, is used as the absorber 32. The primer 33 consists of a mixed polymeric preparation containing some acrylonitrile. The coextrudate is stretched by 500% in the longitudinal direction (that is to say in the direction in which the materials 31, 32, 33, 34 emerge from the extruder head 30) and by 700% in the transverse direction. After having been biaxially stretched, the polymer film 35 has a thickness of approximately 35 μm, the absorber layer 36 has a thickness of 10-20 μm, the primer layer 37 has a thickness of 1-3 μm and the adhesion layer 38 has a thickness of 10-20 μm. Depending on the embodiment, other production conditions and other compositions and dimensions of the individual layers are possible.

The coextrudate having the layer sequence 39 is wound spirally onto the aforementioned optically transparent winding core for subsequent production of the data memory 1, so as to obtain an optical information carrier with a number of stacked layer sequences, each having a polymer carrier (the polymer film 35), an absorber layer 36, a primer layer 37 and an adhesion layer 38. In this case, the adhesion layer 38 of the coextrudate is next to the winding core, so that the innermost turn or layer sequence is bonded to the winding core.

In a variant of the production method explained with reference to FIG. 2, the layers assigned to a plurality of layer sequences are coextruded together. The extruder head used for this has a separate outlet opening for each individual layer. As a result, the layers coextruded together are all stacked. For example, if each layer sequence comprises four layers as in FIG. 2, and the layers of two layer sequences are intended to be coextruded together, the associated extruder head has eight outlet openings, and eight layers are stacked in the coextrudate. After having been extruded, the coextrudate may then be biaxially stretched, as explained above. The information carrier of a data memory can subsequently be wound from the coextrudate, in a similar way to that described in conjunction with FIG. 2.

FIG. 3 shows a schematic cross section through a data memory 40 whose optical information carrier comprises a coextrudate 42 in which the layers of all the layer sequences are coextruded together in the way explained above. The coextrudate 42 is laid bent around a central core 44 to form a ring, and it extends in the radial direction from the periphery 45 of the core 44 to an outer periphery 46. The ends of the coextrudate 42 meet on a line 48. The individual layers of the information carrier hence extend not spirally, as in the examples explained above, but instead concentrically. The line 48 is detected by the write and read device, and it does not therefore interfere with the function of the data memory 40.

The two innermost layer sequences 50 and 51, as well as a further layer sequence 52, are indicated in FIG. 3 with an exaggerated thickness that is not true to scale. Each of the layer sequences has the same structure, as explained with reference to the layer sequence 52: A polymer carrier in the form of a polymer film 54 is followed by an absorber layer 55, which is in turn followed by a further intermediate layer 56.

In a variant of the method leading to the data memory according to FIG. 3, the layers of a number of layer sequences, but not all the layer sequences, are coextruded together. After a ring has been bent from a coextrudate as in FIG. 3, another ring of the coextrudate is placed around it. Even more rings may optionally be applied radially outward. In this embodiment, the individual layers again have a substantially concentric profile. In this way, it is possible to produce information carriers which have a relatively large extent in the radial direction, which would not be readily possible when using a single coextrudate, because of its limited flexibility.

FIG. 4 shows a hollow cylindrical shape 60, which is wound in a coil fashion from a coextrudate strip 62. The coextrudate strip 62 contains the layers, which have been coextruded together, of a plurality of, and advantageously all, the layer sequences for a plurality of optical information carriers and, in the exemplary embodiment, it is wound around a cylindrical shape (not shown in FIG. 4) which extends in the central region 64. The coextrudate strip 62 may protrude from the end sides 66 and 67 of the hollow cylindrical shape 60, although this is not shown in FIG. 4. Optionally, one or more further plies of a coextrudate strip may be wound on in a coil fashion, in a similar way to a variants of the method explained with reference to FIG. 3. Information carriers for a plurality of data memories may be cut or sawn from a hollow cylindrical shape 60.

FIG. 5 shows the result of a further embodiment of the method. In this case, a data memory 70 whose optical information carrier has an inner periphery 71 and an outer periphery 72 is shown in schematic cross section. The information carrier is annular, and it is cut or sawn from a seamless tube. During manufacture of the seamless tube, the layers of all the layer sequences of the data memory 70 are coextruded together. In this case, the individual layers are advantageously arranged concentrically with one another. In FIG. 5, as an example, two layer sequences 74 and 75 are indicated with a thickness that has been enlarged in a way which is not true to scale, each of them consisting of two layers as illustrated with the aid of the layer sequence 75. These are the layer for a polymer carrier 76 and an absorber layer 77. An adhesion layer is unnecessary in this embodiment, since all the layers are manufactured by being coextruded together and they adhere to one another from the start. The material for the polymer carrier 76, or alternatively another material, may be applied with a larger material thickness in the region of the inner periphery 71 and in the region of the outer periphery 72, in order to form a wall for the information carrier of the data memory 70.

In the case of the data memory 70 as well, it is conceivable to biaxially stretch the polymer carrier 76. This may be done, for example, by the action of an internal pressure in the radial direction at elevated temperature on the inner periphery 71 of the tube, and hence in the longitudinal direction on the (closed) end sides of the tube. Advantageously, annular information carriers for a plurality of data memories 70 are cut or sawn from the tube.

1. A method for producing a data memory (1; 40; 70) with an optical information carrier which comprises a plurality of stacked layer sequences (10, 12; 39; 50, 51, 52; 74, 75) designed for information storage, each having a polymer carrier (11; 35; 54; 76) designed for information storage and an intermediate layer (12; 36, 37, 38; 55, 56; 77), wherein a plurality of layers (35, 36, 37, 38) of at least one layer sequence (39) are coextruded.

2. The method as claimed in claim 1, characterized in that the layers (35, 36, 37, 38) assigned to a layer sequence (39) are coextruded and the information carrier is wound spirally therefrom.

3. The method as claimed in claim 1, characterized in that the layers assigned to a plurality of layer sequences are coextruded together and the information carrier is wound spirally therefrom.

4. The method as claimed in claim 1, characterized in that the layers (54, 55, 56) of a plurality of, and preferably all, the layer sequences (50, 51, 52) are coextruded together.

5. The method as claimed in claim 4, characterized in that the layers (50, 51, 52) coextruded together are bent into a ring (42) after having been extruded.

6. The method as claimed in claim 4, characterized in that the layers coextruded together are wound in a coil fashion to form a hollow cylindrical shape (60) after having been extruded.

7. The method as claimed in claim 6, characterized in that annular information carriers for a plurality of data memories are cut from a hollow cylindrical shape (60).

8. The method as claimed in claim 1, characterized in that the layers (76, 77) of all the layer sequences (74, 75) are coextruded together in the form of a seamless tube, the individual layers (76, 77) preferably being arranged concentrically with one another.

9. The method as claimed in claim 8, characterized in that annular information carriers for a plurality of data memories (70) are cut from a tube.

10. The method as claimed in one of claims 1 to 9, characterized in that the refractive index of the polymer carrier (11; 35; 54; 76) can be locally altered by heating.

11. The method as claimed in claim 10, characterized in that an absorber (36; 55; 77) is assigned to the polymer carrier (35; 54; 76), which absorber is designed to absorb a write beam at least partially, and to locally deliver the heat thereby produced at least partially to the polymer carrier (35; 54; 76).

12. The method as claimed in one of claims 1 to 11, characterized in that the coextruded layers (35, 36, 37, 38) are biaxially stretched after having been extruded.

13. The method as claimed in one of claims 1 to 12, characterized in that a polymer film (11; 35; 54) is used as polymer carrier.

14. The method as claimed in one of claims 1 to 13, characterized in that an adhesion layer (12; 38) is used as intermediate layer.

15. The method as claimed in one of claims 1 to 14, characterized in that the refractive index of the intermediate layer (12; 36, 37, 38; 55, 56; 77) differs only slightly from the refractive index of the polymer carrier (11; 35; 54; 76).

16. The method as claimed in one of claims 1 to 15, characterized in that the information carrier is formed around a central core (44).
